(19) United States
(12) Patent Application Publication
(10) Pub. No.: US 2026/0227246 A1
(43) Pub. Date: Aug. 6, 2026

(54) SENSOR ARRANGEMENT

(71) Applicant: TDK Electronics AG, Muenchen (DE)

(72) Inventor: Jordi Basiana Martí, Berlin (DE)

(21) Appl. No.: 19/128,894

(22) PCT Filed: Nov. 14, 2023
(86) PCT No.: PCT/EP2023/081715

§ 371 Date: May 9, 2025

(30) Foreign Application Priority Data
Nov. 21, 2022 (DE) 10 2022 130 679.8

(51) Int. Cl. G01K 1/14; G01K 7/22

(52) U.S. Cl. CPC G01K 1/14; G01K 7/22

(57) ABSTRACT

In an embodiment, a temperature sensor arrangement includes a basic body, a metal body connected to the basic body, a central housing, wherein the basic body and the metal body are at least partly arranged inside the central housing, at least one NTC thermistor arranged within the metal body, at least one terminal configured for electrically connecting the sensor arrangement, an inner sealing arranged between the metal body and the central housing, wherein the inner sealing is configured for sealing an interior of the sensor arrangement against an environment.

### CROSS-REFERENCE TO RELATED APPLICATIONS

This patent application is a national phase filing under section 371 of PCT/EP 2023/081715, filed Nov. 14, 2023, which claims the priority of German patent application no. 102022130679.8, filed Nov. 21, 2022, each of which is incorporated herein by reference in its entirety.

### TECHNICAL FIELD

The present invention relates to a sensor arrangement.

### BACKGROUND

When using NTC—(Negative Temperature Coefficient)—based temperature sensors in applications where 100% sealing to the environment is required, i.e. in automotive applications, the use of technically complex, heavy and expensive turned metal husks is so far inevitable if a fast response time is needed (t63<3 s in liquid).

However, current solutions do not fulfill all requirements at once. They either provide a fast response time but have complex housings and are heavy or they are light and easy to produce (full plastic sensor), but provide a very slow response time (t63>15 s in liquid).

### SUMMARY

Embodiments provide a sensor arrangement which solves the above mentioned problems.

According to one embodiment, a temperature sensor arrangement is described. The temperature sensor arrangement (short: sensor arrangement) is adapted for measuring a temperature in a liquid, e.g. in water and/or in oil. The sensor arrangement may be intended for a use in automotive applications (e.g. for e-motor, transmission, coolant circuit etc.).

The sensor arrangement comprises a basic body. The basic body comprises plastic. In particular, the basic body is a molded plastic component. Thus, the basic body is very easy to produce and is very light-weighted. The basic body is an inner body. In particular, the basic body is arranged at least partly in an interior of the sensor arrangement.

The sensor arrangement further comprises a metal body. The metal body is sleeve-shaped. The metal body is hollow. The metal body comprises an open end and a closed end. The metal body comprises a metal husk. The metal body is connected, preferably non-releasable connected, to the basic body, e.g. clamped, snap-fitted or glued.

The sensor arrangement further comprises a central housing. The central housing comprises plastic. The central housing may be molded. Thus, the central housing is also a very light-weighted component. The basic body and the metal body are at least partly arranged inside the central housing. The basic body is connected to the central housing, e.g. clipped or screwed to the central housing.

The sensor arrangement further comprises at least one NTC thermistor. The NTC thermistor is arranged within the metal body. The sensor arrangement further comprises at least one terminal for electrically connecting the sensor arrangement.

The terminal is arranged inside the basic body. The at least one terminal and the at least one NTC thermistor are overmolded. The basic body may be used for overmolding the NTC thermistor and the terminal. In other words, the NTC thermistor and the at least one terminal may be overmolded by a plastic material of the basic body.

The sensor arrangement further comprises an inner sealing. The inner sealing may comprise an O-Ring. An inner diameter d of the inner sealing may be 3.5±0.14 mm. A thickness t of the inner sealing may be 1.5±0.08 mm.

The inner sealing is arranged inside the central housing. The inner sealing is arranged between the metal body, in particular an outer surface of the metal body, and the central housing, in particular an inner surface of the central housing.

The inner sealing is adapted and arranged to seal an interior of the sensor arrangement against the environment. This means that the inner sealing is specifically designed/shaped and placed and that there is a specific interrelation between the inner sealing and further components of the sensor arrangement to seal the interior of the sensor arrangement.

The inner sealing assures the complete sealing of the sensor arrangement where it is mounted as due to the inner sealing liquid is prevented to protrude inside the sensor arrangement.

The inner sealing may seal against the central housing. In other words, the inner sealing may prevent liquid from protruding between the central housing and further components of the sensor arrangement, e.g. the metal body and/or the basic body. Accordingly, the liquid is prevented to protrude inside the sensor arrangement.

Thus, a reliable, light-weighted and easy to produce sensor arrangement having a very fast response time is provided.

According to one embodiment, the inner sealing is supported by the basic body. In other words, the inner sealing may lie on the basic body. In this case, the metal body may comprise a smooth or straight outer surface.

The basic body may comprise a connector. The connector may be molded. Basic body and connector may be integrally built, i.e. they may constitute a single component of the sensor arrangement. The connector may be adapted and arranged for connecting the metal body and the basic body to one another. The inner sealing may be arranged on the basic body at the position of the connector. In this way, a reliable inner sealing of the sensor arrangement may be provided.

According to one embodiment, the metal body comprises a flange. In other words, a step may be present on the outer surface of the metal body (i.e. the outer surface may not be smooth/straight). The inner sealing may be arranged on the flange of the metal body. Thus, the inner sealing may be-at least partly-supported by the metal body. In this way, an interior of the sensor arrangement may be reliably sealed against the environment.

According to one embodiment, the metal body comprises a deep drawn metal husk. With the introduction of the inner sealing, the sensor arrangement can use the easy to produce, cost-effective and light deep drawn metal husk, while keeping a fast response time. The conventional turned husks are much heavier than the deep drawn husks. Accordingly, by using a deep drawn metal husk a significantly lighter sensor arrangement can be achieved as compared to conventional sensor arrangements.

According to one embodiment, the response time of the sensor arrangement is very fast. In water, the sensor arrangement may comprise a response time t63<2 s. Thus, a very effective sensor arrangement is provided.

According to one embodiment, the central housing is designed to connect the sensor arrangement to an application. This means that the central housing has a very specific shape for enabling a connection of the sensor arrangement to the application. The central housing may have an outer shape that is adaptable. In outer words the outer shape of the central housing can be adjusted depending on different mounting locations and/or depending on required mounting features.

A core design (metal body/husk, basic body) of the sensor arrangement can be the same no matter what the customer interface may be while the central housing is adaptable to the specific mounting situation. Thus, a much higher degree of sustainability and the most cost-effective solution can be achieved.

According to one embodiment, the temperature sensor arrangement further comprises at least one fastening means. The fastening means may be adapted and arranged for fastening the sensor arrangement to an application. The fastening means may be located on an outer side of the central housing. The fastening means may be part of the central housing. In particular, the fastening means and the central housing may be integrally built.

The central housing and, in particular, the fastening means may be designed/adapted according to specific mounting situations. In other words, the fastening means may be adaptable.

The fastening means may comprise at least one clip element for enabling a snap-fit connection of the sensor arrangement to an application, for example. Alternatively, the fastening means may comprise a lug. A metal bushing may be provided in the lug for enabling a screwed connection of the sensor arrangement with an application. Alternatively, the fastening means may comprise a thread, in particular an outer thread of the central housing.

All in all, a very versatile and flexibly applicable sensor arrangement is provided which can be adapted to specific customer interfaces.

According to one embodiment, an operating temperature of the sensor arrangement is between −40° C. and 150° C. Thus, a sensor arrangement is provided which can be used in a wide variety of applications.

According to a further embodiment, a use of a sensor arrangement is described. The sensor arrangement is the same as the sensor arrangement described above. Thus, all features described in connection with the sensor arrangement apply for the use of the sensor arrangement and vice versa.

The sensor arrangement may be used for a temperature measurement in liquid for sealed systems. In particular, the sensor arrangement may be immersed at least partly into a liquid (e.g. water or oil) for measuring a temperature of the liquid. The sensor arrangement may be intended for a use in automotive applications (e.g. for e-motor, transmission, coolant circuit etc.).

Due to the specific configuration of the sensor arrangement described above, a very fast and effective temperature measurement is provided. The sensor arrangement is completely sealed and, thus, very reliable and durable.

### BRIEF DESCRIPTION OF THE DRAWINGS

Further features, refinements and expediencies become apparent from the following description of the exemplary embodiments in connection with the figure.

FIGS. 1A and 1B show a sensor arrangement according to a first embodiment;

FIGS. 2A and 2B show a sensor arrangement according to a second embodiment;

FIG. 3 shows a perspective view of a sensor arrangement according to a second embodiment;

FIG. 4 shows a sectional view of the sensor arrangement according to FIGS. 2A, 2B and 3 mounted in an application;

FIG. 5 shows a sectional view of a metal body according to the second embodiment; and

FIG. 6 shows a sectional view and a top view of an inner sealing of the sensor arrangement.

### DETAILED DESCRIPTION OF ILLUSTRATIVE EMBODIMENTS

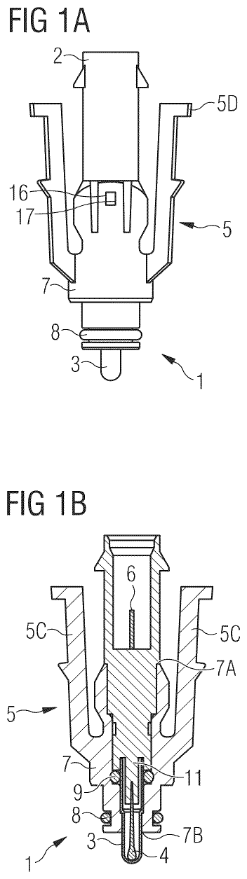

In FIGS. 1A and 1B, a temperature sensor arrangement 1 (short: sensor arrangement 1) according to a first embodiment is shown. The sensor arrangement 1 is an immersion temperature sensor arrangement. In other words, the sensor arrangement 1 is adapted for measuring a temperature in a liquid, e.g. in water and/or in oil. The sensor arrangement 1 can be used in a wide temperature range. An operating temperature of the sensor arrangement 1 is between −40° C. and 150° C. The sensor arrangement 1 has a high accuracy at both temperature ends. Preferably, the sensor arrangement 1 is used for automotive applications.

The sensor arrangement 1 comprises a plastic basic body 2. The basic body 2 is molded. The basic body 2 is an inner body which means that the basic body 2 is arranged at least partly in an interior of the sensor arrangement 1, which will be described later on in detail. An outer diameter of the basic body 2 may be adjustable to different application interfaces (e.g. different pipe diameters, etc.).

The sensor arrangement 1 further comprises a metal body 3. The metal body 3 comprises aluminum. The metal body 3 is hollow. The metal body 3 is sleeve-shaped. The metal body 3 has an open end and a closed end. The metal body 3 comprises a metal husk, in particular a deep-drawn metal husk. In this embodiment, the metal body 3 comprises a smooth outer surface. In other words, no steps are present on the outer surface of the metal body 3.

In an interior of the metal body 3 an NTC thermistor 4 is provided (FIG. 1B). The NTC thermistor 4 is arranged close to the closed end of the metal body 3. The NTC thermistor 4 is overmolded with a plastic material of the basic body 2.

The metal body 3 is connected to the basic body 2. The metal body 3 may be clamped or snap-fitted to the basic body 2, for example. In this embodiment, the basic body 2 comprises a connector 11. The connector 11 is part of the basic body 2. In other words, the connector 11 and the basic body 2 constitute one single molded component of the sensor arrangement 1. The connector 11 partly protrudes into an interior of the metal body 3 for connecting the metal body 3 and the basic body 2 to one another.

The metal body 3 and the basic body 2 are arranged partly in a central housing 7. The central housing 7 comprises plastic. The central housing 7 is a molded component. The central housing 7 has a top opening 7A and a bottom opening 7B (FIG. 1B). The metal body 3 and, thus, the NTC thermistor 4 arranged inside the metal body 3, protrudes partly from the bottom opening 7B. The basic body 2 protrudes partly from the top opening 7A.

The basic body 2 is connected to the central housing 7. For example, the basic body 2 and the central housing 7 are connected by a snap-fit connection. For this purpose, the basic body 2 comprises at least one first locking means 16, e.g. a lug, and the central housing 7 comprises at least one mating second locking means 17, e.g. a protrusion (see FIG. 1A). Of course, all different kinds of locking means are conceivable, e.g. lugs, protrusions, clips, resilient arms, threads etc. The basic body 2 and the central housing 7 are firmly connected to one another by mechanical cooperation of the first and second locking means 16, 17.

The sensor arrangement 1 further comprises terminals 6 for electrically connecting the sensor arrangement 1 (FIG. 1B). The respective terminal 6 is arranged inside the basic body 2. As it is the case for the NTC thermistor 4, the respective terminal 6 is overmolded.

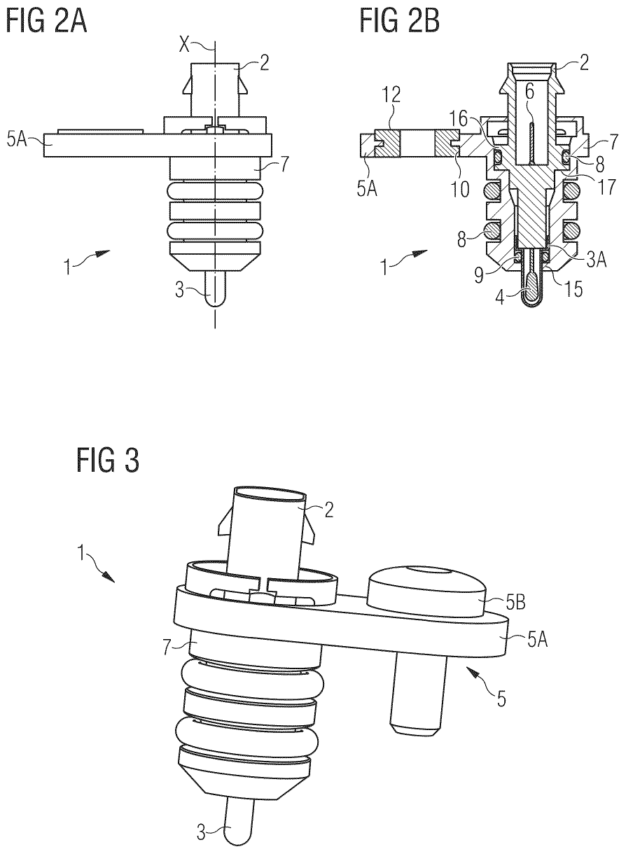

The sensor arrangement 1 further comprises a plurality of sealing elements 8, i.e. inner and outer O-Rings. The sealing elements 8 are arranged on an outer side of the central housing 7 (see FIGS. 1A, 1B, 2A, 2B, for example) and/or on an outer side of the basic body 2 between the basic body 2 and the central housing 7 (see, for example FIG. 2B). The sealing elements 8 are used for providing a sealing of the sensor arrangement 1 and for preventing leakage.

The sensor arrangement 1 constitutes a completely sealed system, i.e. it is completely sealed against the environment. For this purpose, the sensor arrangement 1 further comprises an inner sealing 9 (FIG. 1B). The inner sealing 9 comprises an O-Ring. An inner diameter d of the inner sealing 9 may be 3.5±0.14 mm (see FIG. 9). A thickness t of the inner sealing 9 may be 1.5±0.08 mm (FIG. 9).

In contrast to the previously mentioned sealing elements 8, the inner sealing 9 is arranged between the metal body 3, in particular an outer surface of the metal body 3, and the central housing 7, in particular an inner surface of the central housing 7. The inner sealing 9 is in direct mechanical contact with the metal body 3.

The inner sealing 9 is adapted and arranged to seal an interior of the sensor arrangement 1 against the environment. The inner sealing 9 assures the complete sealing of the sensor arrangement 1 where it is mounted as due to the inner sealing 9 liquid is prevented to protrude from a bottom side of the sensor arrangement 1 along the metal body 3 and inside the sensor arrangement 1.

According to the embodiment shown in FIGS. 1A and 1B, the inner sealing 9 lies on the basic body 2. In particular, the inner sealing 9 is arranged on the basic body 2 where the connector 11 is molded. In other words, in this embodiment the inner sealing 9 is supported by the basic body 2, in particular by a circumferential projection of the connector 11 of the basic body 2. By means of the inner sealing 9, a completely sealed sensor arrangement 1 is provided which is reliable, light and which has a very fast response time. In particular, in water the sensor arrangement 1 comprises a response time t63<2 s.

Only due to the introduction of the inner sealing 9, the sensor arrangement 1 can use the easy to produce, cost-effective and light deep drawn metal husk, while keeping a fast response time. Accordingly, by using a deep drawn metal husk as metal body 3 a significantly lighter sensor arrangement 1 can be achieved as compared to conventional sensor arrangements.

In addition to the features described above, the sensor arrangement 1 is adaptable. The central housing 7 is adaptable to the specific applications/customer interfaces in which the sensor arrangement 1 can be used. In particular, the central housing 7, i.e. an outer shape of the central housing 7, can be adapted to different mounting locations and/or depending on required mounting features.

A core design (metal body 3, basic body 2, terminals 6 and NTC thermistor 4) of the sensor arrangement 1 remains substantially unchanged no matter what the customer interface may be while the central housing 7 is adaptable to the specific mounting situation.

This will be described in the following in more detail:

The sensor arrangement 1 comprises at least one fastening means 5 which is adapted and arranged for fastening the sensor arrangement 1 to an application. This fastening means 5 is located on an outer side of the central housing 7. The fastening means 5 is part of the central housing 7. In particular, the fastening means 5 and the central housing 7 are integrally built.

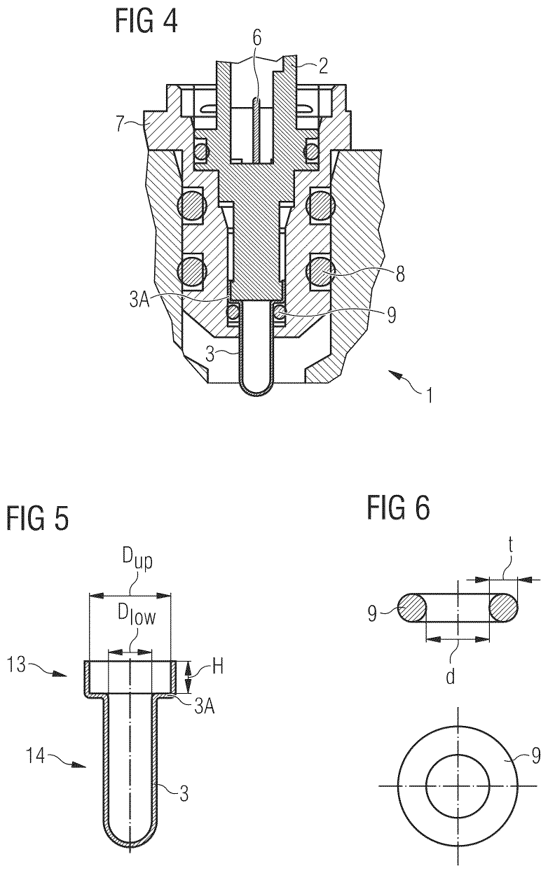

The said fastening means 5 can be adapted according to the way how the sensor arrangement 1 is to be mounted in the application. According to the embodiment shown in FIGS. 1A and 1B, the fastening means 5 is designed to comprise resilient clip elements 5C and/or hooks 5D for enabling a snap-fit connection of the sensor arrangement 1 to an application. The clip elements 5C protrude from the outer surface of the central housing 7 and are designed to mechanically cooperate with matching structures of the application e.g. indentations (not explicitly shown) for firmly connecting the sensor arrangement 1 with the application. Another example would be that the central housing 7 is designed with a bayonet lock (not explicitly shown) or with a thread (see FIG. 4) for enabling a screwed connection with the application.

In particular, the fastening means 5 can be any form of fastening structure that fits the fastening structure of the application while the basic body 2 and the metal body 3 remain substantially unchanged. In this way, a high degree of sustainability and the very cost-effective solution is provided.

FIGS. 2A, 2B, 3 and 4 show a sensor arrangement 1 according to a second embodiment. In the following, the differences of the sensor arrangement 1 shown in FIGS. 2A, 2B, 3 and 4 as compared to the sensor arrangement shown in FIGS. 1A and 1B are described.

In contrast to the embodiment shown in FIGS. 1A and 1B, the basic body 2 is screwed to the central housing 7. For this purpose, the locking means 16 of the basic body 2 comprises a thread, in particular an outer thread (FIG. 2B). The second locking means 17 of the central housing 7 comprises a mating thread. The basic body 2 and the central housing 7 are connected by mechanical cooperation of the threads. A sealing element 8 is arranged between the inner surface of the central housing 7 and the outer surface of the basic body 2, in particular in a groove of the threads (FIGS. 2B and 4) to provide a sealing between the basic body 2 and the central housing 7.

Furthermore, in contrast to the embodiment shown in FIGS. 1A and 1B, the metal body 3 does not comprise a smooth outer surface. Rather, the metal body 3 comprises a flange 3A (see FIGS. 2B and 5), i.e. a circumferential bulge. The flange 3A is located in the region of the open (i.e. upper) end of the metal body 3 (see, in particular, FIG. 5).

Accordingly, an upper part 13 of the metal body 3 has a greater diameter Dᵤₚ as compared to a lower part 14 of the metal body 3, i.e. the part which protrudes from the central housing 7. The diameter Dᵤₚ of the upper part 13 may be 5.4±0.05 mm. A diameter D_{low} of the lower part 14 may be 2.9±0.1 mm. A height H of the upper part 13 may be 2.1±0.1 mm (see in this context FIG. 5).

The basic body 2, in particular a lower end of the basic body 2, is partly inserted into the upper part 13 of the metal body 3 for connecting the metal body 3 and the basic body 2 to one another, as can be gathered from FIG. 2B. Preferably, the basic body 2 and the metal body 3 are clamped or glued to one another. The NTC thermistor 3 is arranged in the lower part 14 of the metal body 3.

As the metal body 3 comprises the flange 3A, the inner sealing 9 is arranged between the metal body 3 and the central housing 7 on the flange 3A of the metal body 3 (see FIGS. 2B and 4). Accordingly, the inner sealing 9 is—at least partly—supported by the metal body 3.

Further, in this embodiment and in contrast to the embodiment shown in FIGS. 1A and 1B, the inner sealing 9 is supported by the central housing 7, in particular by a circumferential protrusion 15 of the central housing 7. The circumferential protrusion 15 limits the bottom side of the central housing 7 from the environment. By means of the inner sealing 9, a complete sealing between the metal body 3 and the central housing 7 is achieved, as described above.

In addition to that and in contrast to the embodiment shown in FIGS. 1A and 1B, the sensor arrangement 1 does not provide a snap fit mechanism to be connected to an application. Rather, in this embodiment, a screw in solution is provided. For this purpose, the central housing 7 and, in particular the fastening means 5, comprises a lug 5A (see FIGS. 2A, 2B and 3). The lug 5A extends transversally to a main longitudinal axis X of the sensor arrangement 1. The lug 5A and the central housing 7 are integrally built, i.e. they constitute a single molded component. The lug 5A comprises a through-hole 10. A metal bushing 12 is arranged inside the through hole 10 for enabling a screw 5B to be introduced for fixing the sensor arrangement 1 to the application.

Finally, in this embodiment, the outer surface of the central housing 7 is threaded. Sealing elements 8 are arranged in grooves of the thread (FIGS. 2B, 3 and 4) to provide an external sealing of the sensor arrangement 1.

In a further embodiment (not explicitly shown in den Figures) the thread arranged on the outer surface of the central housing 7 may be used for fixing (i.e. screwing) the sensor arrangement 1 to the application. In this case, the previously described fastening means 5 comprising the lug 5A and the screw 5B may be redundant.

With regard to all other components of the sensor arrangement 1, reference is made to the description in connection with FIGS. 1A and 1B.

The invention is not limited to the embodiments by the description based thereon. Rather, the invention encompasses any new feature as well as any combination of features, which in particular includes any combination of features in the claims, even if this feature or combination itself is not explicitly stated in the claims or embodiments.

1.-19. (canceled)

20. A temperature sensor arrangement comprising:
a basic body;
a metal body connected to the basic body;
a central housing, wherein the basic body and the metal body are at least partly arranged inside the central housing;
at least one NTC thermistor arranged within the metal body;
at least one terminal configured for electrically connecting the temperature sensor arrangement; and
an inner sealing arranged between the metal body and the central housing,
wherein the inner sealing is configured for sealing an interior of the temperature sensor arrangement against an environment.

21. The temperature sensor arrangement according to claim 20, wherein the inner sealing is supported by the basic body or by the metal body.

22. The temperature sensor arrangement according to claim 20, wherein the inner sealing is configured for sealing against the central housing.

23. The temperature sensor arrangement according to claim 20, wherein the basic body comprises a connector configured for connecting the metal body and the basic body with one another, and wherein the inner sealing is arranged on the basic body at a position of the connector.

24. The temperature sensor arrangement according to claim 20, wherein the metal body comprises a flange, and wherein the inner sealing is arranged on the flange of the metal body.

25. The temperature sensor arrangement according to claim 20, wherein the metal body comprises a deep drawn metal husk.

26. The temperature sensor arrangement according to claim 20, wherein the inner sealing comprises an O-Ring.

27. The temperature sensor arrangement according to claim 20,
wherein the central housing is configured for connecting the sensor arrangement to an application,
wherein the central housing has an adaptable outer shape, and
wherein the outer shape is adaptable to different mounting locations and/or mounting features.

28. The temperature sensor arrangement according to claim 20, further comprising at least one fastening element configured for fastening the sensor arrangement to an application.

29. The temperature sensor arrangement according to claim 28, wherein the fastening element is part of the central housing, and wherein the fastening element and the central housing are integrally built.

30. The temperature sensor arrangement according to claim 28, wherein the fastening element comprises at least one clip element.

31. The temperature sensor arrangement according to claim 28, wherein the fastening element comprises a lug, and wherein a metal bushing is provided in the lug.

32. The temperature sensor arrangement according to claim 20, wherein the basic body comprises a molded plastic component.

33. The temperature sensor arrangement according to claim 20, wherein the at least one terminal and the at least one NTC thermistor are over-molded.

34. The temperature sensor arrangement according to claim 20, wherein the central housing comprises plastic.

35. The temperature sensor arrangement according to claim 20, wherein sensor arrangement is configured for operating between −40° C. and 150° C.

36. The temperature sensor arrangement according to claim 20, wherein sensor arrangement is configured to provide a response time t63<2 s for water.

37. The temperature sensor arrangement according to claim 20, wherein the metal body is connected directly to the basic body.

38. The temperature sensor arrangement according to claim 20, wherein the basic body comprises a connector which is part of the basic body, wherein the connector partly protrudes into an interior of the metal body for connecting the metal body and the basic body to one another.

39. A method for operating the temperature sensor arrangement according to claim 20, the method comprising:
measuring a temperature in a liquid for sealed systems.
